(19) United States
(12) Patent Application Publication
(10) Pub. No.: US 2009/0232266 A1
(43) Pub. Date: Sep. 17, 2009

(54) SIGNAL PROCESSING DEVICE

(75) Inventors: Kenichi KAMADA, Kawasaki (JP); Masayuki Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/365,320

(22) Filed: Feb. 4, 2009

(30) Foreign Application Priority Data
Mar. 14, 2008 (JP) 2008-065429

(51) Int. Cl. H04L 7/00

(52) U.S. Cl. 375/372

(57) ABSTRACT

A signal processing device includes a phase shifting unit for supplying a second clock signal having a predetermined phase difference relative to a first clock signal, a head recognition bit adding unit for adding a head recognition bit to a predetermined position of data constituting a packet, an inputting unit for reading out a data signal from the memory in synchronization with the second clock signal, a clock replacing unit for inputting the data signal on the basis of the second clock signal and outputting the data signal on the basis of first clock signal, a data shifting unit for shifting the data signal by an amount corresponding to a predetermined number of clock cycles, and an enable signal generating unit for generating an enable signal for recognizing an available length of the packet after an appearance of the head recognition bit in the output signal.

### CROSS-REFERENCE TO RELATED APPLICATIONS

This application is based upon and claims the benefit of priority of the prior Japanese Patent Application No. 2008-065429, filed on Mar. 14, 2008, the entire contents of which are incorporated herein by reference.

### FIELD

Embodiments discussed herein relate to a signal processing device including a memory interface unit having a phase shifting unit such as a PLL (Phase Locked Loop) circuit.

### BACKGROUND

As a signal processing device for performing various signal processing operations such as test signal generating and detecting operations, devices of the types realized by FPGA (Field Programmable Gate Array) and ASIC (Application Specific Integrated Circuit) are currently available.

A signal processing device of the above mentioned type uses a memory such as a RAM (Random Access Memory) for storing data required for performing various processes. Therefore, the signal processing device of this type includes a memory interface unit for writing data into and reading out data from the memory.

FIG. 1 is a diagram showing a structural example of a memory interface circuit section of an existing signal processing circuit.

In FIG. 1, a signal processing circuit 1 supplies an output clock signal having a predetermined phase difference relative to a reference clock signal to a memory 2 via a PLL circuit 11, supplies memory input signals (address signals, write data signals and other control signals) to the memory 2 in synchronization with the reference clock signal via a flip flop 12, and reads out a memory output signal (a read data signal) from the memory 2 in synchronization with the reference clock signal via a flip flop 13. In the case that the signal processing circuit 1 transmits the memory input signal to and receives the memory output signal from the memory 2 in parallel, the flip flops 12 and 13 are installed in a the number corresponding to the number of bits. The memory interface circuit includes the PLL circuit 11, the flip flop 12 and the flip flop 13. Incidentally, it is known that the signal processing circuit 1 is realized by FPGA or ASIC.

In the signal processing circuit 1 as mentioned above, delays of signals are noticeably observed within the circuit and hence a problem occurs in setting an AC (Alternating Current) timing between the signal processing circuit 1 and the memory 2. Thus, a predetermined phase difference is made between an operation clock and writing and reading clocks of the memory 2 by using the PLL circuit 11 so as to adjust the AC timing between the signal processing circuit 1 and the memory 2.

However, for reasons such as a great delay occurring from when an output from the flip flop 12 for output use is made, to when the output reaches an output terminal of the signal processing circuit 1, it sometimes occurs that it becomes difficult to adjust the AC timings of both the output from the flip flop 12 and an input into the flip flop 13 and hence an interface timing between the signal processing circuit 1 and the memory 2 cannot be realized.

In the case that such a problem as mentioned above occurs, conventionally, a memory input signal such as an address signal has been held for a time period corresponding to a plurality of clock cycles of an output clock signal to stabilize a memory output signal from the memory 2, thereby it becomes possible to realize fetching of data into the circuit as shown in FIG. 2.

However, this above-mentioned method cannot be applied to the case where it is necessary to fetch into the circuit data which are sent from the memory 2 in a burst (continuously) in each clock cycle, as shown in FIG. 3. Therefore, if this method is used in an application requiring high-speed data transfer, a problem, the interface timing between the signal processing circuit 1 and the memory 2 cannot being realized, may occur.

In order to solve this problem, there has been proposed a method of ensuring the AC timing by replacing one clock with another one for data signal. FIG. 4 is a diagram showing a structural example of an interface circuit section in which one clock has been replaced with another one. In FIG. 4, a clock signal for input use of the flip flop 13 in the structure shown in FIG. 1 is replaced with an output clock signal which is an output from the PLL circuit 11 and an FIFO (First In First Out) circuit 14 for use in replacement of one clock with another one (hereinafter, referred to as the clock replacing FIFO circuit) and a flip flop 15 are connected with an output of the flip flop 13 in this order so as to supply an output clock signal from the PLL circuit 11 as a clock signal for input use into the clock replacing FIFO circuit 14, to supply a reference clock signal as a clock signal for output use from the clock replacing FIFO circuit 14 and to supply the reference clock signal as a clock signal of the flip flop 15.

The AC timing between the signal processing circuit 1 and the external memory 2 can be ensured by taking measures shown in FIG. 4. However, replacement of a clock with the reference clock signal is performed, and as a result of which another problem occurs in that the relation between address signals and read data signals which have been output in a burst cannot be correctly recognized. That is, the read data signal output from the flip flop 15 does not correspond to the address signal which has been supplied to the flip flop 12 and a delay of the amount corresponding to several cycles generates between these signals. Therefore, in a situation that data are continuously output, correspondence between each address and the data becomes impossible.

On the other hand, Japanese Laid-open Patent Publication No. 9-16464 discloses a semiconductor integrated circuit having a synchronous interface and a synchronous controlling system using this circuit. However, neither the semiconductor integrated circuit nor the synchronous controlling system can solve the problems caused by the PLL circuit installed to adjust the AC timing between the circuit and the memory as mentioned above.

### SUMMARY

According to an aspect of an embodiment, a signal processing device includes a phase shifting unit for supplying a second clock signal having a predetermined phase difference relative to a first clock signal to a memory, a head recognition bit adding unit for adding a head recognition bit to a predetermined position of data constituting a packet supplied to the memory as a write data signal, an inputting unit for reading out a data signal from the memory in synchronization with the second clock signal and transmitting the data signal, a clock replacing unit for inputting the data signal from the inputting unit on the basis of the second clock signal and outputting the data signal on the basis of first clock signal, a data shifting unit for shifting the data signal output from the clock replacing unit by an amount corresponding to a predetermined number of clock cycles, and an enable signal generating unit for generating an enable signal for recognizing an available length of the packet output from the data shifting unit after an appearance of the head recognition bit in the output signal from the clock replacing unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram showing a structural example of a memory interface circuit section of an existing signal processing circuit;

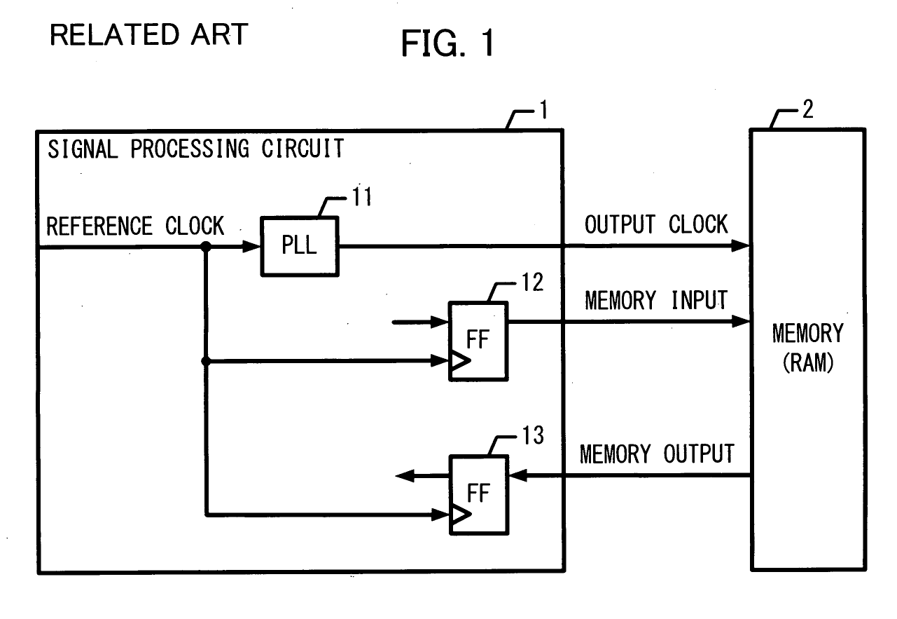

FIG. 2 is a timing chart showing one example of timings of respective signals in the circuit shown in FIG. 1;

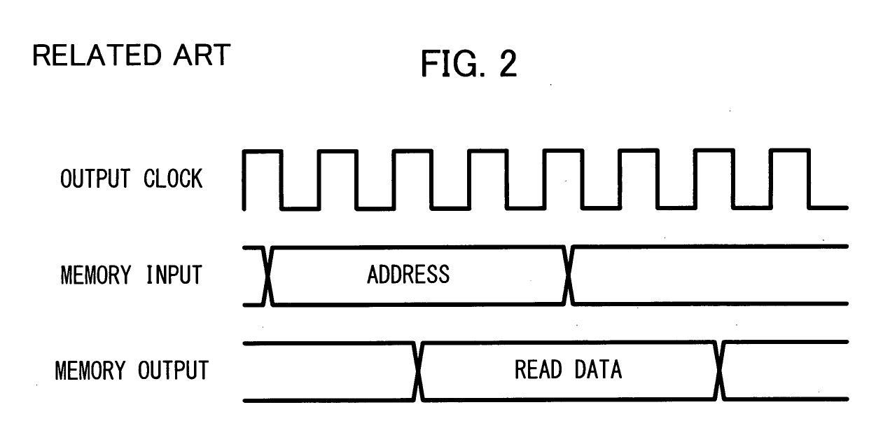

FIG. 3 is a timing chart showing another example of the timings of respective signals in the circuit shown in FIG. 1;

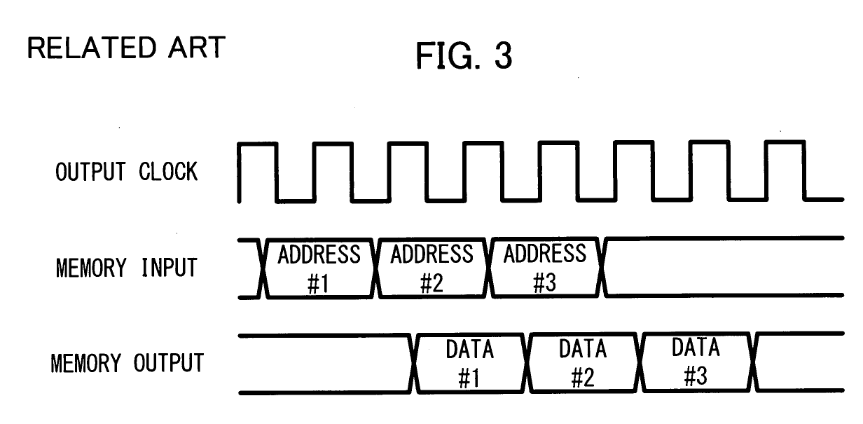

FIG. 4 is a diagram showing a structural example of an interface circuit section in which a clock has been replaced with another one;

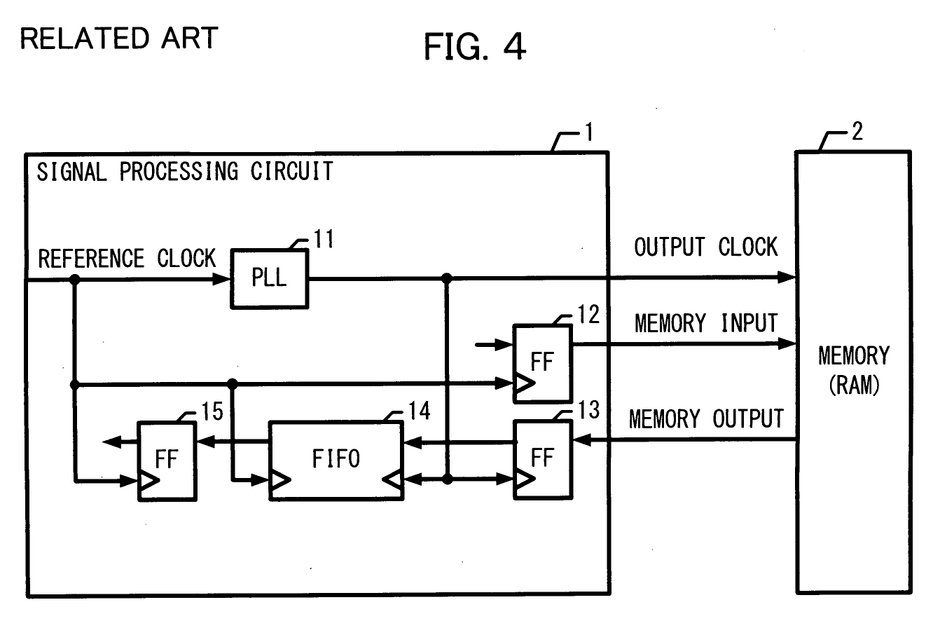

FIG. 5 is a diagram showing a structural example of a memory interface circuit section of a signal processing circuit according to a first embodiment;

FIG. 6 is a diagram showing an example of data stored in a memory in the first embodiment;

FIG. 7 is a timing chart showing one example of timings of respective signals upon reading out data from the memory in the first embodiment;

FIG. 8 is a timing chart showing another example of the timings of respective signals upon reading out data from the memory in the first embodiment;

FIG. 9 is a diagram showing a structural example of a memory interface circuit section of a signal processing circuit according to a second embodiment;

FIG. 10 is a timing chart showing an example of timings of respective signals upon reading out data from the memory in the second embodiment; and

FIG. 11 is a diagram showing a structural example of a signal processing circuit according to a third embodiment which is applied to test packet sending-out.

### DESCRIPTION OF EMBODIMENTS

Next, preferred embodiments will be described with reference to the accompanying drawings.

### First Embodiment

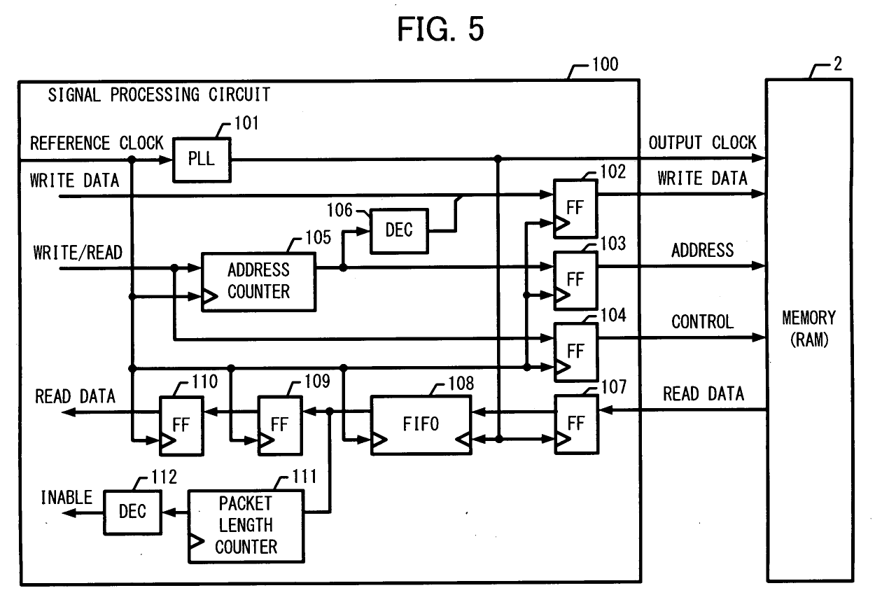

FIG. 5 is a diagram showing a structural example of a memory interface circuit section of a signal processing circuit according to the first embodiment.

In FIG. 5, a signal processing circuit 100 is realized by, for example, FPGA or ASIC. The signal processing circuit 100 includes a PLL circuit 101 for receiving a reference clock signal and supplying an output clock signal having a predetermined phase difference relative to the reference clock signal to a memory 2 such as a RAM. The PLL circuit 101 need only have a phase shifting function, so that the PLL circuit 101 can be generally called a phase shifting unit.

The signal processing circuit 100 also includes a flip flop circuit 102 for outputting a write data signal to the memory 2 in synchronization with the reference clock signal, a flip flop circuit 103 for outputting an address signal to the memory 2 in synchronization with the reference clock signal, and a flip flop circuit 104 for outputting a control signal to the memory 2 in synchronization with the reference clock signal. The signal processing circuit 100 further includes a flip flop circuit 107 for fetching thereinto a read data signal from the memory 2 in synchronization with the output clock signal from the PLL circuit 101. Note that in the case that the write data signal, the address signal and the read data signal are interfaced in parallel between the signal processing circuit 100 and the memory 2, the flip flop circuits 102, 103 and 107 are installed in a number corresponding to the number of parallel lines. Each of the flip flop circuits 102, 103 and 107 need only have a function of outputting a signal in synchronization with a clock signal supplied thereto and hence these circuits can be generally called outputting unit. On the other hand, the flip flop circuit 107 need only have a function of inputting a signal in synchronization with a clock signal supplied thereto and hence this circuit can be generally called an inputting unit.

The signal processing circuit 100 further includes an address counter circuit 105 for generating an address signal in synchronization with the reference clock signal corresponding to a writing and reading instruction signal, and supplying the address signal to the flip flop circuit 103. And the circuit 100 further includes a decoder circuit 106 for detecting that an output from the address counter circuit 105 has turned to “1” to output “1” to a predetermined head recognition bit (which will be described later) of the write data signal which will be supplied to the flip flop 102. In the case that the number of areas of data to be written into and read out from the memory 2 is fixed in the range from 1 to n, the address counter circuit 105 generates the address signals in the order of “0”, “1”, “2”, . . . and “n-1”. The address counter circuit 105 and the decoder circuit 106 can be called a head recognition bit adding unit as a unit because these circuits are combined with each other to have a head recognition bit adding function.

The signal processing circuit 100 still further includes a clock replacing FIFO circuit 108 for inputting an output signal from the flip flop circuit 107 by using the output clock signal from the PLL circuit 101 as a clock signal for input use and using the reference clock signal as a clock signal for output use. The clock replacing FIFO circuit 108 need only have a function of inputting and outputting signals at different timings and hence this circuit can be generally called a clock replacing unit.

The signal processing circuit 100 still further includes a flip flop circuit 109 for fetching thereinto the output signal from the clock replacing FIFO circuit 108 in synchronization with the reference clock signal to output the fetched output signal. And the circuit 100 still further includes a flip flop circuit 110 for fetching thereinto the output signal from the flip flop circuit 109 in synchronization with the reference clock signal to output the fetched output signal as a read data signal. The reason why the flip flop circuits 109 and 110 are installed at two stages following the clock replacing FIFO circuit 108 lies in the fact that since the circuit 100 is constructed so as to write the head recognition bit “1” into the second data counting from the head of the packet, the data is shifted a number of times which is one more than necessary so as to set a timing with the operations of a packet length counter circuit 111 and a decoder circuit 112 which will be described later, thereby correctly recognizing the head position of the packet. Therefore, the flip flop circuits 109 and 110 can be called a data shifting unit.

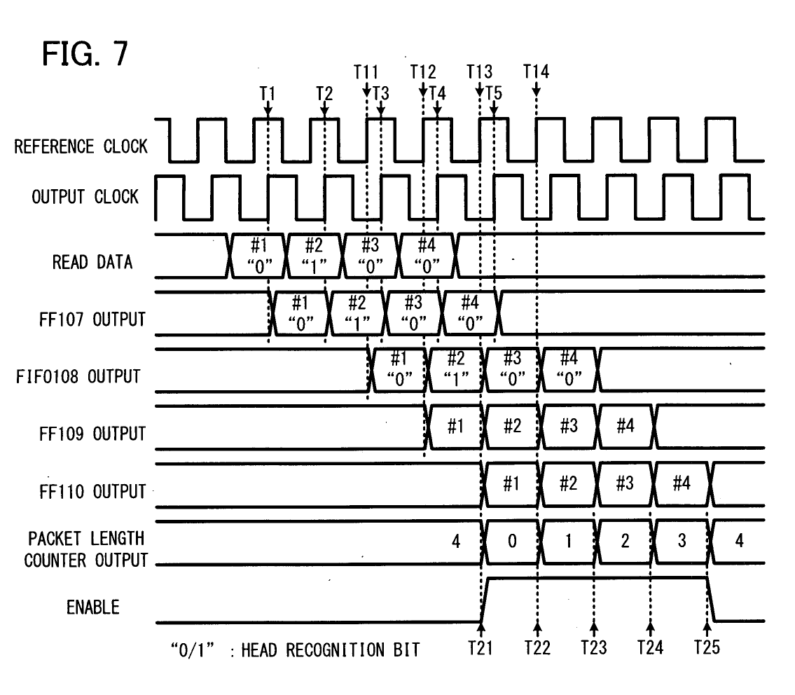

The signal processing circuit 100 still further includes the above mentioned packet length counter circuit 111 into which “0” is loaded in the case that the head recognition bit of the output signal (the data) from the clock replacing FIFO circuit 108 is “1” to count the data incoming frequency, thereby counting the packet length. And the circuit 100 still further includes the above mentioned decoder circuit 112 for detecting that an output signal from the packet length counter circuit 111 is in the range of predetermined values to output an enable signal. The range of predetermined values is the range from “0” to “n−1” for the packet length “n”, that is, in the example shown in the described FIG. 7 later, in the range from “0” to “3” with the packet length defined as “4”. The packet length counter circuit 111 sets a counter value out of the range of values which are decoded by the decoder circuit 112 and keeps it constant when it is not used. The packet length counter circuit 111 and the decoder circuit 112 can be called an enable signal generating unit.

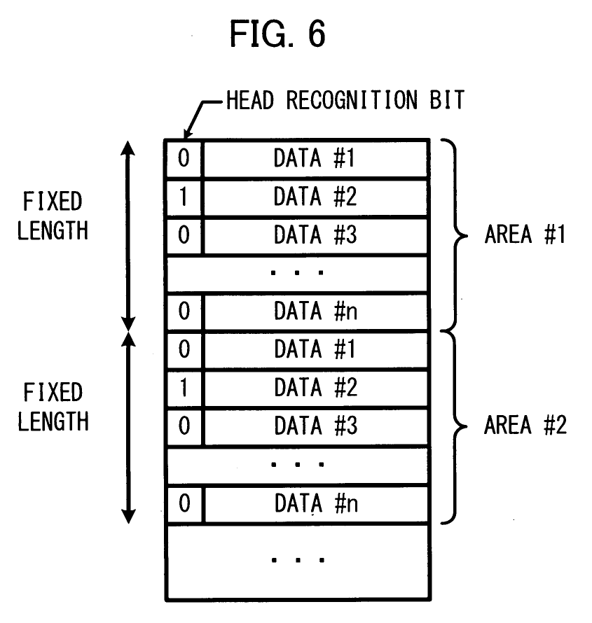

FIG. 6 is a diagram showing an example of data stored in the memory 2. In the example shown in the drawing, the packet length is fixed to “n”. In addition, one unused bit in a data area within one address is defined as a head recognition bit, the head recognition bit of the second data in each packet is set to “1” and others are set to “0”s. Owing to these settings, a process can be started from a moment at which data of the second address has been received after reading out of data has been started in a state that the head address is read out when the data is not used (on standby), by which the process to be performed when it is not used can be simplified. That is, when the data is not used, it sometimes occurs that the data is periodically read out with the address fixed to the head of an area (for example area #1, or area #2) in order to confirm the operation of the memory 2. However, if the head recognition bit “1” is present in data of the head address, it cannot be set as a condition for starting the process and hence a more complicated controlling structure in which whether the data is in a not-used state is taken into consideration should be set up.

In the example shown in FIG. 5, when a write data signal is output from the flip flop circuit 102 to the memory 2, “0” or “1” is provided to the position of the head recognition bit in the write data from the decoder circuit 106, by which the head recognition bit is written into the memory 2. That is, when counting of addresses (relative addresses starting from the head address in the area) is progressed by the address counter circuit 105 in the order of “0”, “1”, “2”, . . . and “n-1”, the decoder circuit 106 outputs “1” as the head recognition bit only in the case that the second address “1” is counted and outputs “0”s in other cases.

FIG. 7 is a timing chart showing an example of timing of each signal generated upon reading out data from the memory 2 in the first embodiment, showing the case where the packet length has been defined as “4” and four data of one packet of one area have been continuously read out (#1-#4 illustrated in FIG. 7).

In the example show in FIG. 7, under a condition that the reference clock signal and the output clock are in a phase relation shown in the drawing, the memory 2 outputs the read data signal in response to the address signal supplied from the flip flop circuit 103 and the control signal supplied from the flip flop circuit 104 in synchronization with the reference clock signal.

The flip flop circuit 107 fetches thereinto the read data signals from the memory 2 at output clock signal rising timings T1, T2, T3 and T4 and then outputs the fetched signals to the next stage.

The clock replacing FIFO circuit 108 fetches thereinto the output signal from the flip flop circuit 107 at the output clock signal rising timing. However, because signal transmission from the flip flop circuit 107 to the clock replacing FIFO circuit 108 is delayed and signal fetching takes time, timings at which effective data are fetched are delayed by one, that is, the effective data are fetched at the timings T2, T3 and T4 and then at a timing T5. Then, the clock replacing FIFO circuit 108 outputs data which have been fetched thereinto directly before outputting to the next stage at timings T11, T12, T13 and T14 in synchronization with the reference clock signal.

The flip flop circuit 109 fetches thereinto the output signal from the clock replacing FIFO circuit 108 in synchronization with the reference clock signal and then outputs the fetched signal to the next stage. Likewise, the flip flop circuit 110 fetches thereinto the output signal from the flip flop circuit 109 in synchronization with the reference clock signal and then outputs the fetched signal as a read data signal for use in processing performed within the signal processing circuit 100.

On the other hand, into the packet length counter circuit 111, “0” is loaded at a timing T21 at which the head recognition bit in the output signal from the clock replacing FIFO circuit 108 turns to “1” and then the packet length counter circuit 111 continues counting up data at data incoming timings T22, T23, T24 and T25. The packet counter circuit 111 stops counting when it has counted up to “4” which is out of the range of the values to be decoded by the decoder circuit 112.

Then, the decoder circuit 112 detects that the output signal from the packet length counter circuit 111 is in the range from “0” to “3” to output an enable signal which turns to “1”s for a time period counting from the timing T21 to the timing T25. That is, the output signal from the clock replacing FIFO circuit 108 is shifted twice by the flip flop circuits 109 and 110, so that a result of decoding of the values in the range from “0” to “3” by the decoder circuit 112 can be used as an enable signal of the data while the packet length counter circuit 111 is counting up a part of the packet length.

A processing unit, not shown, incorporated into the signal processing circuit 100 can recognize the head of data constituting one packet with the enable signal turning to “1”. Since the packet length is fixed, this processing unit can recognize the end of the data constituting the packet by acquiring four data in the example shown in the drawing. In addition, this processing unit can recognize that no succeeding data is present with the enable signal turning to “0”.

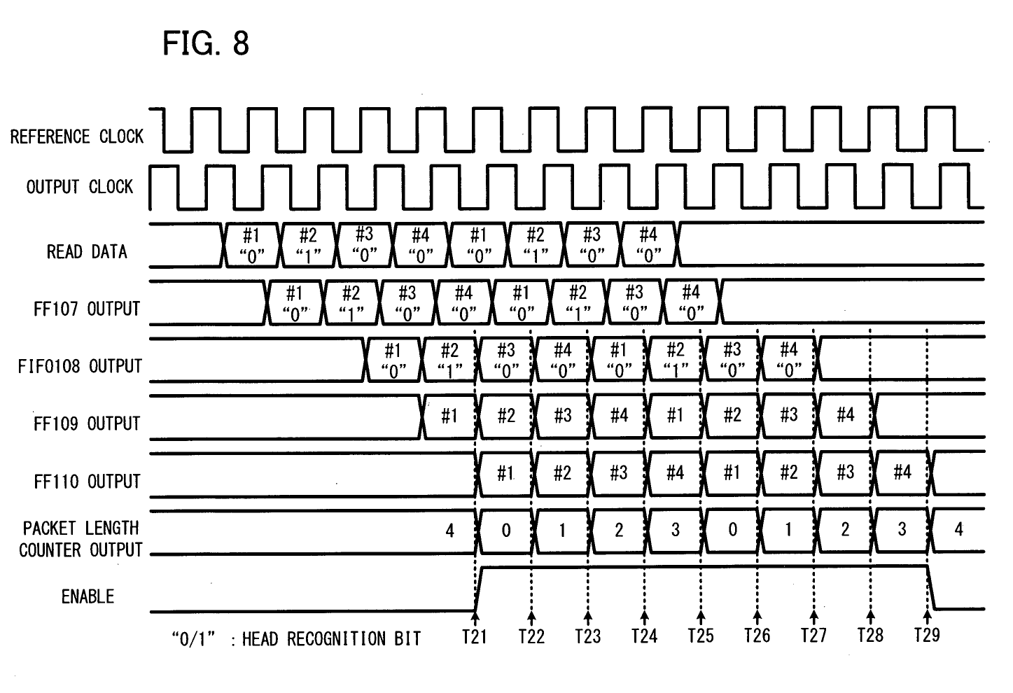

FIG. 8 shows an example in which the packet length has been defined as “4” and eight data of two packets in two areas have been successively read out (#1-#4 illustrated in FIG. 8).

The example shown in FIG. 8 is the same as that shown in FIG. 7 except that the number of data has been increased until the read data signal is obtained from the flip flop circuit 110.

In the example shown in FIG. 8, the head recognition bit of the output signal from the clock replacing FIFO circuit 108 turns to “1” at a timing T25, by which “0” is loaded into the packet length counter circuit 111. And then the packet length counter circuit 111 continues counting up data at data incoming timings T26, T27, T28 and T29. Thus, the decoder circuit 112 outputs an enable signal which turns to “1” for a time period counting from the timing T21 to the timing T29. Therefore, with the enable signal turning to “1”, the head of data constituting the packet can be recognized. In the embodiment shown in FIG. 8, since the packet length is fixed, shifting to the second packet at the timing T25 can be recognized. In addition, with the enable signal turning to “0”, it can be recognized that no succeeding data is present.

### Second Embodiment

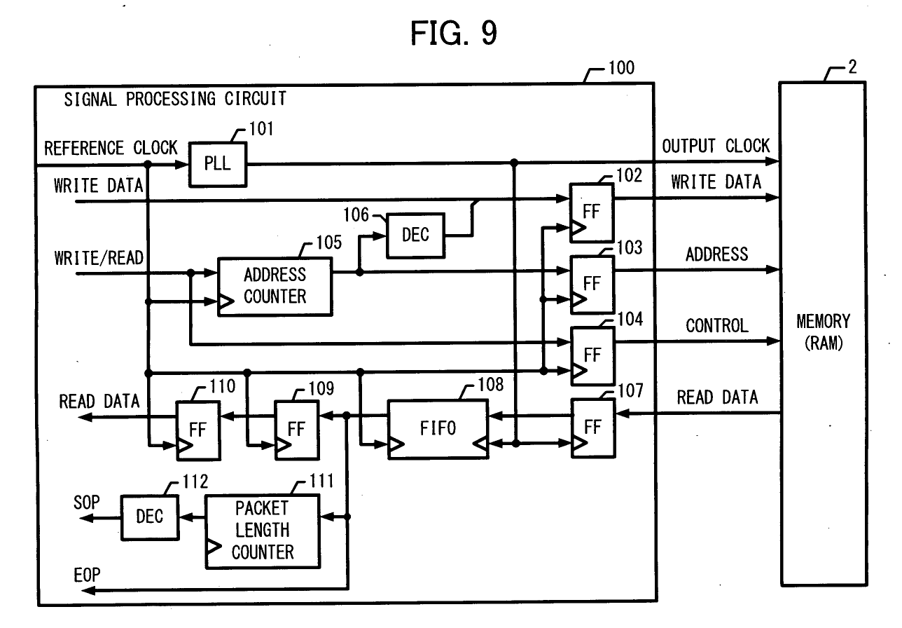

FIG. 9 is a diagram showing a structural example of a memory interface circuit section of a signal processing circuit according to the second embodiment. In the first embodiment, the packet length is fixed, while in the second embodiment, the packet length is made variable.

The structure shown in FIG. 9 differs from that shown in FIG. 5 in that in the address counter circuit 105 for supplying the address signal to the flip flop circuit 103 and the decoder circuit 106, the upper limit value to be counted is set as the maximum packet length.

The decoder circuit 112 installed at the succeeding stage of the packet length counter circuit 111 is designed to detect the case where the counted value is “0” so as to output an SOP (Start Of Packet) signal indicative of the head of a packet concerned. In addition, a signal with which “0” is loaded into the packet length counter circuit 111 in the case that the head recognition bit of the output signal from the clock replacing FIFO circuit 108 is “1” is fetched out as an EOP (End Of Packet) signal indicative of the end of the packet. In this case, the packet length counter circuit 111 and the decoder circuit 112 can be called the enable signal generating unit also.

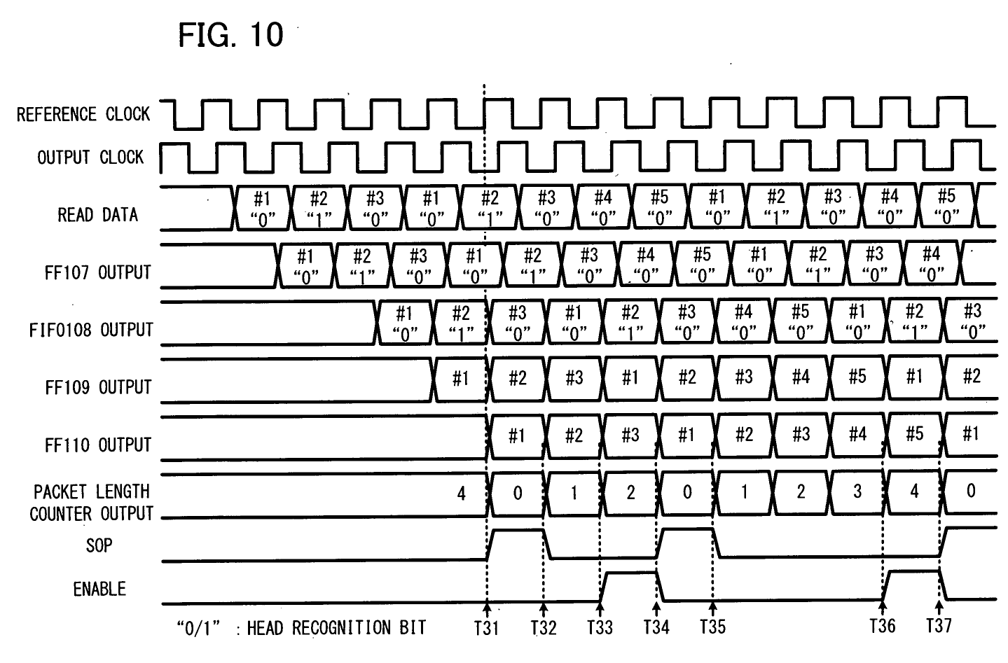

FIG. 10 is a timing chart showing an example of a timing of each signal generated when data is read out from the memory 2 in the second embodiment. FIG. 10 shows the case where three data for a packet length “3” (#1-#3 illustrated in FIG. 10), five data for a packet length “5” (#1-#5 illustrated in FIG. 10) and five data for a packet length “5” (#1-#5 illustrated in FIG. 10) have been continuously read out.

The example shown in FIG. 10 is the same as that shown in FIGS. 7, 8 except that the number of data has been increased until a read data signal is obtained from the flip flop circuit 110.

In the example shown in FIG. 10, the decoder circuit 112 outputs the SOP signal “1” for time periods between timings T31 and T32 and timings T34 and T35 for which the counted value “0” by the packet length counter circuit 111 is detected. That is, a head recognition bit indicative of the second data counting from the next head turns to “1” not only when “0” is firstly loaded into the packet length counter circuit 111 but also before the packet length counter circuit 111 counts up to a value out of the range of values to be decoded, so that “0” is again loaded into the packet length counter circuit 111 which, then, can generate the SOP signal. A processing unit, not shown, incorporated into the signal processing circuit 100 can recognize the head of data constituting the packet with the SOP signal turning to “1”.

In addition, the EOP signal with which “0” is loaded into the packet length counter circuit 111 turns to “1” for time periods between timings T33 and T34 and timings T36 and T37, by which the end of each packet can be recognized. However, in the case that no succeeding packet is present, the EOP signal cannot be generated, so that “1” is falsely set to the head recognition bit in the next packet storing position. Therefore, due to the necessity to recognize that no packet is present after the packet which has been read out, it becomes necessary to manage the number of written packets.

### Third Embodiment

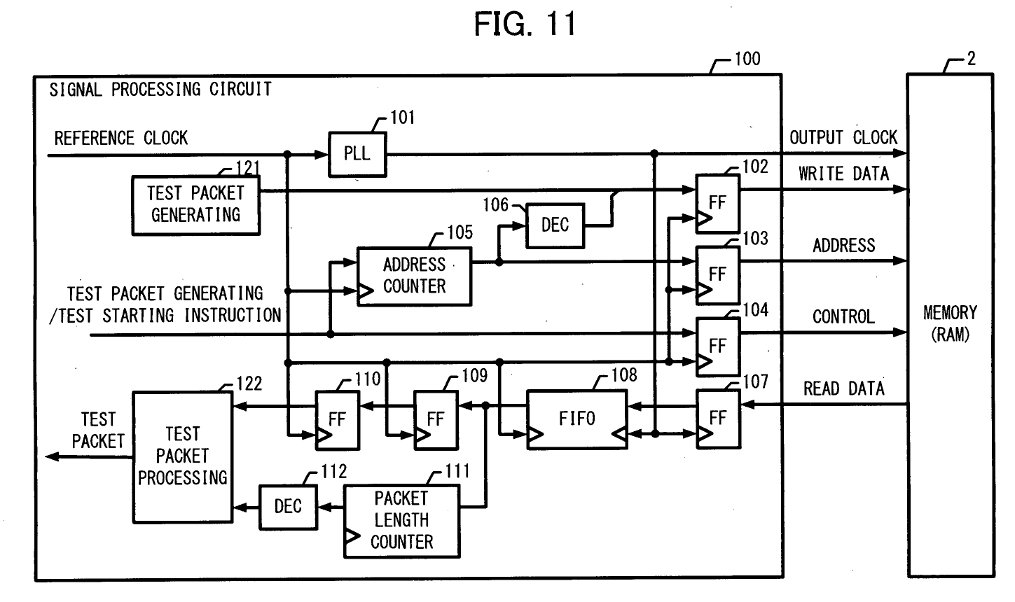

FIG. 11 is a diagram showing a structural example of a signal processing circuit according to the third embodiment which is applied to test packet sending-out. Note that although its fundamental structure is the same as that shown in FIG. 5 in which the packet length is fixed, even the structure shown in FIG. 9 in which the packet length is made variable can be also used in this embodiment.

In the example shown in FIG. 11, as a function unit for providing a write data signal to the flip flop circuit 102, into the signal processing circuit 100, there is incorporated a test packet generating unit 121 for generating a data of a test packet and the writing and reading instruction signals to be supplied to the address counter 105 are replaced with test packet generating and test starting instruction signals.

In addition, there is also incorporated into the signal processing circuit 100, a test packet processing unit 122 for inputting the read data signal output from the flip flop circuit 110 and the enable signal output from the decoder circuit 112 to send out test packets.

The operation of the signal processing circuit 100 shown in FIG. 11 is the same as those of the aforementioned circuits except that the data written into and read out from the memory 2 are data on the test packets. In this embodiment, since the test packets which have been generated are stored in the memory 2 and the stored test packets can be read out from the memory 2 in a burst in each clock cycle, the test packets can be sent out at a high rate.

As described above, according to the embodiments, in a signal processing circuit including a memory interface circuit having a PLL circuit, in the case that data is to be replaced with another data asynchronously, even if addresses are changed in a burst, the relation between each address and read data can be correctly recognized while ensuring an AC timing of interface between the signal processing circuit and a memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A signal processing device comprising:
a phase shifting unit for supplying a second clock signal having a predetermined phase difference relative to a first clock signal to a memory;
a head recognition bit adding unit for adding a head recognition bit to a predetermined position of data constituting a packet supplied to the memory as a write data signal;
an inputting unit for reading out a data signal from the memory in synchronization with the second clock signal and transmitting the data signal;
a clock replacing unit for inputting the data signal from the inputting unit on the basis of the second clock signal and outputting the data signal on the basis of first clock signal;
a data shifting unit for shifting the data signal output from the clock replacing unit by an amount corresponding to a predetermined number of clock cycles; and
an enable signal generating unit for generating an enable signal for recognizing an available length of the packet output from the data shifting unit after an appearance of the head recognition bit in the output signal from the clock replacing unit.

2. The signal processing device according to claim 1, wherein the enable signal generating unit generates the enable signal on the basis of a timing at which a head data signal is output from the data shifting unit and a timing at which an end data signal is output from the data shifting unit after the appearance of the head recognition bit in the output signal from the clock replacing unit.

3. The signal processing device according to claim 1, wherein the head recognition bit is set to “1” only for the second data constituting the packet.

4. The signal processing device according to claim 1, wherein the head recognition bit adding unit comprises:
an address counter circuit for generating an address signal in synchronization with the first clock signal corresponding to a writing and reading instruction signal; and
a decoder circuit for detecting that an output from the address counter circuit has reached a predetermined value to output “1” to a predetermined bit of the write data signal.

5. The signal processing device according to claim 1, wherein the enable signal generating unit comprises:
a packet length counter circuit into which “0” is loaded in the case that the head recognition bit has appeared in the output signal from the clock replacing unit to count data incoming frequency, thereby the packet length counter circuit counting the packet length; and
a decoder circuit for detecting that a value counted by the packet length counter circuit is in the range from “0” to “n-1” to output the enable signal, wherein “n” is the packet length.

6. The signal processing device according to claim 1, wherein the enable signal generating unit comprises: a packet length counter circuit into which “0” is loaded in the case that the head recognition bit has appeared in the output signal from the clock replacing unit to count data incoming frequency, thereby the packet length counter circuit counting the packet length; and
a decoder circuit for detecting that a value counted by the packet length counter circuit is “0” to output a signal indicative of the head of the packet, and outputting a signal indicative of the end of the packet at a timing which “0” is loaded into the packet length counter circuit.
